(19) United States
(12) Patent Application Publication
(10) Pub. No.: US 2025/0332962 A1
(43) Pub. Date: Oct. 30, 2025

(54) METHOD FOR OPERATING AN ELECTRIC VEHICLE

(71) Applicant: DAIMLER TRUCK AG, Leinfelden-Echterdingen (DE)

(72) Inventors: Thomas WOLF, Flehingen (DE); Juergen ELSER, Weissach im Tal (DE); Markus REIFF, Esslingen am Neckar (DE)

(21) Appl. No.: 18/868,419

(22) PCT Filed: May 9, 2023
(86) PCT No.: PCT/EP2023/062315

§ 371 Date: Nov. 22, 2024

(30) Foreign Application Priority Data
May 25, 2022 (DE) 10 2022 113 285.4

(51) Int. Cl. B60L 58/40; B60L 50/75

(52) U.S. Cl. CPC B60L 58/40; B60L 50/75; B60L 2240/66; B60L 2260/50

(57) ABSTRACT

A method for operating an electric vehicle having a fuel cell system and a traction battery involves specifying a target state of charge of the traction battery using the topography in the surroundings of the vehicle, for which the position of the vehicle is determined and elevations in a specified perimeter around the vehicle are determined from a digital map, from which a conclusion is drawn about the probable occurrence of uphill and/or downhill sections, whereupon the target state of charge is specified depending on the probability of uphill and/or downhill sections.

### BACKGROUND AND SUMMARY OF THE INVENTION

Exemplary embodiments of the invention relate to a method for operating an electric vehicle, having a fuel cell system and a traction battery.

A typical problem with hybrid vehicles having a primary drive unit and a traction battery, which is also referred to as a HV or high-voltage battery, is the division of power from the battery and the other drive unit. An optimal use of the battery requires that road sections with an increased electric power demand from the battery and road sections with an increased quantity of power generated by recuperation, which has to be stored in the battery, can be reliably estimated.

In the case of a hybrid having an internal combustion engine and an additional storage battery, EP 3 124 302 A1 describes a control apparatus that adjusts the state of charge of the battery according to inclines or declines using a route pre-planned via a navigation system, so that energy optimization can take place. The problem of the set-up described there is that it only functions if the route travelled is planned using a navigation device. It assumes that the navigation system is used, i.e., that the user actively enters the route destination. Furthermore, it assumes that a person driving the vehicle keeps exactly to this route and does not deviate from the planned route. Such a deviation would make a complex recalculation necessary, which is then possibly not able to optimally adjust the battery's state of charge at the time of the route change. If the navigation system is not used, the method can similarly not be used.

For further prior art, reference can be made to DE 10 2020 128 221 A1. A fuel cell vehicle, i.e., an electrically driven vehicle having a fuel cell, is described therein. In order to prevent the vehicle speed from dropping when the fuel cell has to be derated due to reaching its maximum power, the route can be optimized so that steep inclines that could lead to such a power limitation depending on a load towed by the vehicle can be bypassed.

Exemplary embodiments of the present invention are directed to an improved operating method for an electrically driven vehicle having a fuel cell system and traction battery which reduces the risk of the speed being restricted and optimizes the energy usage.

The method according to the invention provides that a target state of charge of the battery is specified using the topography in the surroundings of the vehicle. For this purpose, the position of the vehicle is determined via a satellite navigation system for example, and elevations in a specified perimeter around the vehicle are determined from a digital map. From these elevations, a conclusion is drawn about the probable occurrence of uphill and/or downhill sections, whereupon the target state of charge is specified depending on the probability of uphill and/or downhill sections.

Differently to planning the energy distribution for a main route input in a navigation system, the method according to the invention is able to perform a meaningful estimate in order to adjust the target state of charge accordingly, independently of the use of a navigation system or independently of whether the vehicle remains on this planned main route or not. Thus, incurred energy can be optimally stored and the required electric power, which exceeds the maximum power of the fuel cell system, can be used from the battery when needed. Thus, on the one hand, the entire energy consumption is optimized and, on the other hand, the danger of the speed being restricted, for example in the case of corresponding inclines, is reduced.

According to a very advantageous embodiment of the method according to the invention, it can therefore be provided that in the case of higher probability of uphill sections than downhill sections, a target state of charge of more than 50 to 60% of the battery capacity is specified. According to a preferred further development, the default is in the range of more than 80% of the battery capacity. Thus, power incurred, for example when braking, can be stored in the battery during recuperation. Due to the higher probability of uphill sections than downhill sections, it can however be assumed that in this case the vehicle is travelling in a relatively flat region and at most inclines are to be expected, for example when leaving a relatively large valley or similar. A relatively high state of charge of preferably approx. 80% of the battery capacity or in particular more than 80% of the battery capacity is therefore significant here, as larger amounts of energy from recuperation do not have to be expected. Instead, it has to be expected that power will be required from the traction battery so that any occurring uphill sections, for which there is a much higher probability than downhill sections here, can be driven with additional power from the traction battery, so that derating is avoided.

According to a further very favorable embodiment of the method according to the invention, it can also be provided that in the case of higher probability of downhill sections than uphill sections, a target state of charge of less than 50 to 60% of the battery capacity is specified, according to an advantageous further development thereof, in particular of less than 30% of the battery capacity. If there is a higher probability of downhill sections than uphill sections, then the vehicle is on a type of plateau, for example at high ground, from which there is a significantly higher probability of descending via downhill sections than of having to negotiate an uphill section. In this case, it can be assumed with a relatively high probability that recuperated power is generated to a greater extent during braking. The relatively low state of charge of the battery of less than 30% in such a situation ensures that all or at least a large proportion of this generated energy can be stored, in order to then be available for driving purposes again.

According to a further embodiment of the method according to the invention, it can now also be provided that in the case that the probability of uphill sections is about the same as the probability of downhill sections, the target state of charge is specified in the range from 50 to 60% of the battery capacity. Such an average state of charge of the traction battery can then always be advantageous when downhill and uphill sections are expected with a similarly high probability due to the determined topography. This can be the case, for example, in hilly or mountainous terrain, when downhill and uphill sections typically change on the vast majority of plausible routes. The traction battery is then held at an average state of charge in order to be able to actively provide support and store energy, with it being expected that both scenarios are equally likely to occur.

A particularly favorable embodiment of the method according to the invention can provide that the perimeter in which the topography is determined has a radius of approximately 50 km. In this perimeter around the vehicle, the topography is therefore determined in order to be prepared for the potential uphill and downhill sections that occur there, preferably in the sense mentioned above. This perimeter can be specified as having an angle of 360° around the vehicle according to an advantageous embodiment of the method according to the invention, so that the topography is evaluated from the vehicle in all directions. This can be significant, in particular, when a navigation system is not used and there is no other type of information about a potential destination.

An advantageous embodiment of the method according to the invention can, however, be applied in the case of a route planned via a navigation system to a known destination without a planned route or routes frequently travelled in the past when the vehicle is in a similar position. In this case, the angle of the perimeter can be restricted to an angle section along the potentially expected direction of travel. Here as well, this is not restricted to a specific main route in order to plan as precisely as possible along this route which battery state of charge provides the ideal conditions. Instead, the perimeter in which the topography is determined is accordingly reduced using the rough direction of travel. This reduction can be specified depending on other parameters, for example, such that the angle section is reduced to 90 to 270° along the direction of travel. At 90°, this would mean that, starting from the vehicle, one segment of a circle at 45° is viewed to the right based on the direction of travel and one to the left of this direction of travel, and at 270° it would accordingly be 135° in each case. As a result, on the one hand, less effort is required to evaluate the topography and, on the other hand, greater height differences in the rear area of the direction of travel, which would lead accordingly to greater downhill or uphill sections, can be disregarded, thus improving the quality of the estimation.

Depending on whether the direction of travel is based on a planned route from a navigation device, an estimate from the past or, for example, a destination position taken from a calendar entry, the angle can be restricted to varying degrees. In the case of a relatively precise route specified by a navigation device, the angle section can be selected to be somewhat smaller, i.e., in the range from 90 to 120°, whereas in the case of a relatively uncertain assumption of a preferred direction of travel based on past journeys or similar, it can be selected to be correspondingly larger, for example 200 to 270°, in order to ensure a sensible operating strategy.

Overall, lower hydrogen consumption is therefore possible through optimized use of the traction battery. Furthermore, and this applies in particular to expected uphill sections, better vehicle performance, for example preventing the vehicle speed from being restricted, can be ensured by optimizing the use of the traction battery. In addition, the method according to the invention in one of its embodiments described above ultimately also permits more careful handling of both the traction battery and the fuel cell system, so that an improvement in the service life can be achieved through the efficiency-optimized use.

Further advantageous embodiments of the method result from the exemplary embodiment which is represented in more detail below with reference to the figures.

### BRIEF DESCRIPTION OF THE DRAWING FIGURES

Here:

FIG. 1 shows a schematically indicated vehicle for carrying out the method according to the invention;

FIG. 2 shows a first example case in which the vehicle is located in a flat area;

FIG. 3 shows a further example case in which the vehicle is located on a plateau; and

FIG. 4 shows a third example case in which the vehicle is located in a hilly or mountainous region.

### DETAILED DESCRIPTION

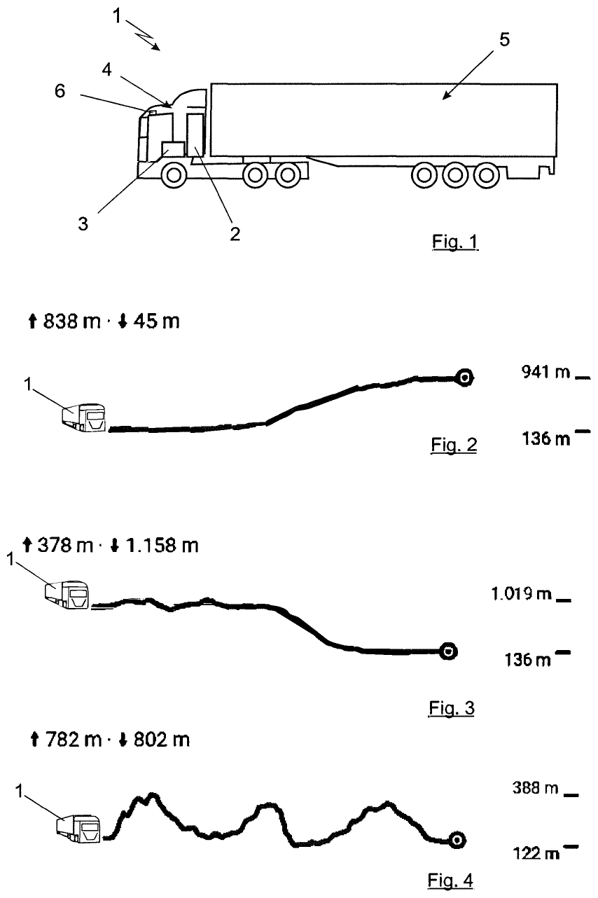

FIG. 1 shows a very schematic representation of a vehicle 1 having a fuel cell system 2 and a traction battery 3. The vehicle may be a commercial vehicle, here in the form of a heavy goods vehicle, consisting of a tractor unit 4 and a semi-trailer 5. Other vehicles with or without trailers, which could be formed both as commercial vehicles as well as passenger cars, are however also conceivable.

The vehicle 1 has a GPS sensor 6 in the region of its tractor unit 4 which is shown schematically here. Using this GPS sensor, the vehicle 1 can determine its position. Using the position of the vehicle 1 found via the GPS sensor 6, the topography in the surroundings of the vehicle 1 can now be determined via a vehicle-internal control device and/or a vehicle-external server, not shown. For this purpose, elevations are read out from a digital map, which is stored in the vehicle 1 or on the vehicle-external server, and these elevations are evaluated in a specified perimeter of, for example, 50 km around the vehicle 1, when concrete information is not present for a potential route section or direction of travel. Depending on which elevation differences there are between the elevation of the vehicle 1 in the current position and the potentially travelled terrain, conclusions are drawn about uphill and/or downhill sections, so that then a probability of uphill sections on the one hand and downhill sections on the other hand inside the specified perimeter can be determined. A target state of charge of the traction battery 3 is now specified using these probabilities for uphill and downhill sections.

This is to be described in the following with reference to FIGS. 2 to 4, for three purely exemplary cases.

The example according to FIG. 2 shows the vehicle 1 here in a largely flat region, in which higher terrain is towards the edges. Correspondingly, the potential inclines determined in the perimeter are at 838 m, the potential downhill sections in contrast are only at 45 m. The example shows purely by way of example a region of the Autobahn A5 (federal motorway) between Karlsruhe and Basel. In such a region, the probability of an incline is relatively high, the probability of a downhill section is however very low. The target state of charge of the traction battery 3 is therefore specified here as high, for example having more than 80% of the battery capacity. As a result, ideal use of the traction battery 3 is possible. Since downhill sections are only to be expected to a very limited extent, a correspondingly fully charged battery can be used without the danger that recuperation energy cannot be stored. Simultaneously, the high state of charge of the traction battery 3, can be used to prepare to support of the electric drive of the vehicle 1 from the battery in the case of the uphill sections which are to be expected with a much higher probability.

The second exemplary embodiment according to FIG. 3 shows the route on a plateau with the same logic as in the representation of FIG. 1, in which the vehicle 1 is already at a relatively high level, so that the expected altitude difference at uphill sections adds up to approx. 380 m, the expected altitude difference for downhill sections adds up to the almost tripled value of approx. 1160 m. The example used for the topography in this case is the Bundesstraβe B500 (federal highway) of the so-called “black forest high road”. In this situation, the probability that a downhill section is being driven is very high, whilst the probability of an uphill section is assessed as lower. The target state of charge of the traction battery 3 can be specified as comparatively low here, for example in the region of approximately 30% of the battery capacity, and even lower again in a similar scenario with an even lower probability of uphill sections. In such a situation, it has to be specifically assumed that there is a relatively high probability that a downhill section will be driven. In this case, a relatively large amount of recuperation energy is incurred by wear-free braking by means of the electric drive engine. The very low target state of charge of the traction battery 3 make it possible to store all or at least a large proportion of this power incurred during recuperation, so that the energy efficiency operation is at the forefront here.

The third example in the representation of FIG. 4 shows the vehicle in the region of a mountainous or hilly section, the scenario of which is assumed to be the autobahn A7 in the region of “Kasseler Berge”. In the relevant perimeter, the topography shown is close to 800 m altitude difference on uphill sections and about the same for downhill sections. Here, it is also considered that both downhill sections are driven as well as uphill sections. In the case, the target state of charge of the traction battery 3 is specified in the mid-range, for example in the range from 50 to 60% of the battery capacity. Such an average state of charge then makes it possible, on the one hand, to provide support when travelling uphill sections and, on the other, to store at least a large proportion of the energy generated during recuperation on downhill sections so that it can then be made available again on the next uphill section.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method for operating an electric vehicle, the method comprising:
determining a position of the electric vehicle, wherein the electric vehicle has at least one fuel cell system and at least one traction battery having a battery capacity;
determining, from a digital map and based on the determined position of the electric vehicle, elevations in a specified perimeter around the electric vehicle;
determining a probability of occurrence of uphill road sections and downhill road sections based on the determined elevations; and
specifying, based on the determined probability of the occurrence of the uphill road sections and the downhill road sections, a target state of charge of the at least one traction battery.

12. The method of claim 11, wherein it is determined there is a higher probability of uphill sections than downhill sections and the target state of charge is specified as being more than 50 to 60% of the battery capacity.

13. The method of claim 12, wherein the target state of charge is specified as being more than 80% of the battery capacity.

14. The method of claim 11, wherein it is determined there is a higher probability of downhill sections than uphill sections and the target state of charge is specified as being less than 50 to 60% of the battery capacity.

15. The method of claim 14, wherein the target state of charge is specified as being less than 30% of the battery capacity.

16. The method of claim 11, wherein it is determined there is a similar probability of uphill sections and downhill sections and the target state of charge is specified in a range of 50 to 60% of the battery capacity.

17. The method of claim 11, wherein the specified perimeter has a radius of 50 km around the electric vehicle.

18. The method of claim 11, wherein the specified perimeter has an angle of 360° around the electric vehicle.

19. The method of claim 11, wherein when there is a driving route planned via a navigation system to a known destination without a planned driving route or when driving routes frequently travelled in past when the electric vehicle is in the determined position, an angle of the perimeter is restricted to an angle section along an expected direction of travel.

20. The method of claim 19, wherein the angle is restricted in a range from 90 to 270°.

21. The method of claim 11, further comprising:
operating the electric vehicle along a road based on the specified target state of charge of the at least one traction battery.
